(19) United States
(12) Patent Application Publication
(10) Pub. No.: US 2005/0221794 A1
(43) Pub. Date: Oct. 6, 2005

(54) Aegis safetynet ™ radiobridge ™

(75) Inventors: Richard Charles Grosser, Palm Desert, CA (US); Eric Dunbar Johnson, Scottsdale, AZ (US)

Correspondence Address: AEGIS ASSESSMENTS, INC., 7975 NORTH HAYDEN RD., SUITE D-363, SCOTTSDALE, AZ, 85258, US

(73) Assignees: Aegis; Assessments, Inc.

(21) Appl. No.: 11/095,848

(22) Filed: Mar. 31, 2005

Related U.S. Application Data
(60) Provisional application No. 60/558,160, filed on Apr. 1, 2004.

(51) Int. Cl. H04B 1/38

(52) U.S. Cl. 455/404.1; 455/403

(57) ABSTRACT

A portable radio bridge which allows most two-way radios to be interconnected regardless of the radio's frequency, modulation or encryption scheme to provide radio interoperability at the scene of a multi-jurisdictional emergency. The device channels the audio output from the external speaker jack on one radio to the microphone input jack on another radio. The process used is time division multiplexing. The device is microprocessor controlled and monitors input channels, determines if someone is speaking, and sends the audio to output channels in specified “talk groups”.

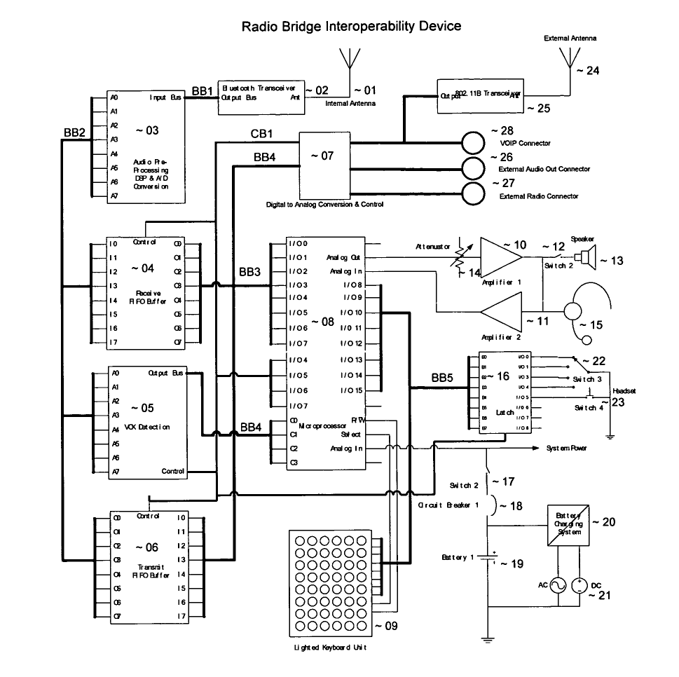

Portable device for facilitating communications between radio and telephonic devices The applicant claims the benefit of an earlier application for a provisional patent filed on Apr. 1, 2004, application No. 60/558,160.

### FIELD OF THE INVENTION

The invention is directed to the problems associated with emergency or disaster situations when agencies or individuals with disparate radio transceivers operating on different frequencies or with different modulation schemes must communicate with each other in a controlled fashion.

### BACKGROUND OF THE INVENTION

A major problem for first responders is the absence of interoperable radio equipment. In emergency situations, various jurisdictions inevitably become involved. Local law enforcement, fire departments and emergency medical personnel often are in a situation where they are equipped with hand-held radios that cannot communicate with one another. Currently, they are operating on different frequencies or use different modulation schemes. The invention solves this problem inexpensively and with no pre-configuration.

### BRIEF SUMMARY OF THE INVENTION

The invention interconnects radios on different frequencies instantly and bridges these devices beyond their normal capabilities. It also allows for interconnection to devices such as telephones, wireless personal area networks, aircraft, amateur radio, military radios and voice-over-internet connections, both wireline and wireless. The invention (hereinafter referred as the “RadioBridge”) can also provide for long-distance microwave relay of communications. It can also interface to digital or analog recording devices. There is currently no simple method for an official to contact and speak to large groups of personnel equipped with various types of radios. The RadioBridge can provide this functionality.

### BRIEF DESCRIPTION OF THE DRAWING

The attached drawing illustrates the details of the RadioBridge. The RadioBridge is composed of various electronic components. Radios or other analog IO (input-output) devices are attached either via a direct cable connection from the microphone/speaker port of the attached device to a connection on the RadioBridge or via a PAN (Personal Area Network, typically IEEE 802.15 generally known as “Bluetooth”). The Bluetooth transceiver 02 is connected to internal antenna 01. The digital audio stream from device 02 is connected to the DSP (digital signal processor) 03 for the purpose of improving the quality of the signal and removal of noise and other artifacts as well as accounting for delays typical with trunked radio systems. The output of the DSP is connected to the common bus BB2. The data is stored in a FIFO memories 04 and 05. These memories as well as control functions are connected to the microprocessor via data buses BB3 and BB4 and control bus CB1. Device 05 consists of a VOX detection system for actuation of the PTT (Push to Talk) function of the radios. All information flows and processing is controlled by the microprocessor 08 which is in turn programmed by the keyboard system 09 which is connected to data bus BB5. The programming allows various 10 devices to be assigned to a specific communications group, or to allow some devices to talk to all groups. The DAC (Digital to Analog Converter) 07 provides interconnection 27 to wired devices, as well as analog audio out port 26, a VoIP port 28 and a wireless VoIP relay link 25 & 26. A local monitoring system (10, 11, 12, 13, 14 and 15) is provided for command and control purposes. This monitoring system is controlled by switches 22 and 23 and is connected to the data bus BB5. The RadioBridge is powered by the rechargeable battery 19. A recharging system 20 is provided and can be powered various external power supplies. A power switch 17 and circuit breaker 18 control the flow of power to the RadioBridge. A battery “fuel gauge” function is implemented in the microprocessor 08.

1. A system to provide interconnection and multiplexing of disparate communications devices in a controlled fashion comprising:
a. An electronic device that will connect to various devices by cables or via a wireless PAN.
b. A system of cables that interface with most extant types of hand-held and fixed-bases radio transceivers.
c. A system that interfaces devices such as mobile phones equipped with PAN devices such as Bluetooth.
d. A system that connects with a telephone line.
e. A system that connects with any mobile telephone equipped with a 2.5 mm headset connector.
f. A system that can relay data as a TCP/IP stream.
g. A system that can relay TCP/IP data via a wireless connection.
h. A system that can increase the range of radio transceivers.
i. A system that can interconnect to a digital or analog recorder.
j. A system that can connect a land-line telephone connection to a large number of disparate radios.
k. A system that can interface to a cordless Bluetooth headset.

2. A self-contained portable system capable of being easily carried by an individual with the following features:
a. A system powered by internal rechargeable batteries for a period of 12 hours.
b. A system powered by external 12 Volt vehicle power.
c. A system powered by 110/220 Volt AC power.
d. A system powered by replaceable dry-cell batteries.
e. A system that is water-resistant.
f. A system that can be instantly deployed without complex set-up, programming or fore-knowledge of what types of devices will be interconnected.
g. A system that can be operated by unskilled personnel with minimal or on-the-spot training.
